(19) United States
(12) Patent Application Publication
(10) Pub. No.: US 2012/0233116 A1
(43) Pub. Date: Sep. 13, 2012

(54) FILE SYNCHRONIZATION METHOD

(76) Inventors: Hironobu FUKAMI, Tokyo (JP); Kei Kubo, San Jose, CA (US)

(21) Appl. No.: 13/044,641

(22) Filed: Mar. 10, 2011

(51) Int. Cl. G06F 17/30

(52) U.S. Cl. 707/620; 707/E17.005; 707/E17.032

(57) ABSTRACT

The present invention is a method of synchronizing files on a system including a client terminal, a management server, a test server and a production server, the method comprising the steps of: detecting, by an application installed on the client terminal, update of a file in a directory which the application manages; creating, by the application, an update history and difference information of the updated file; transmitting, by the application, the update history and the difference information to the management server; updating, by the management server, a file based on the update history and the difference information; transmitting, by the management server, the update history and the difference information to the test server; updating, by the test server, a file based on the update history and the difference information; displaying, by the test server, information of the updated file when a request to access the test server is transmitted by the client terminal; detecting, by the application, a request of deployment; transmitting, by the application, the request to the management server; detecting, by the management server, difference information between file management information of the test server and file management information of the production server; transmitting, by the management server, the detected difference information to the production server; updating, by the production server, a file based on the difference information; and displaying, by the production server, information of the updated file when a request to access the production server is transmitted by the client terminal;

whereby the file of the production server is synchronized with the file of the client terminal.

### BACKGROUND OF THE INVENTION

1. Field of the Invention

The present invention relates to a file synchronization method and a system adapted to implement the file synchronization method.

2. Description of the Related Art

In general, in order to set up and manage a Web server, it is required to prepare a client terminal (local host), a test server and a production server and to install necessary software on the client terminal, the test server and the production server so as to ensure the compatibility of their software environment. In addition, it is required to upload a file edited in a client terminal to a test server and/or a production server by a file transfer software (FTP software or the like).

In a case where several developers set up and manage a Web server collectively, it is required to synchronize data in each client terminal of the several developers with date in a server.

In this way, a developer in charge of the setup and management of a Web server needs to have professional skills of installation of software, initial setting of FTP information and the like and management of file synchronization in a client terminal with a server. That is why the setup and management of a Web server is difficult for a general user.

### SUMMARY OF THE INVENTION

Therefore, the object of the present invention is to provide a method for easily setting up and managing a server without need for professional skills.

The subject matters of the present invention are as follows.
(1) A method of synchronizing files on a system including a client terminal, a management server, a test server and a production server, the method comprising the steps of:

detecting, by an application installed on the client terminal, update of a file in a directory which the application manages;

creating, by the application, an update history and difference information of the updated file;

transmitting, by the application, the update history and the difference information to the management server;

updating, by the management server, a file based on the update history and the difference information;

transmitting, by the management server, the update history and the difference information to the test server;

updating, by the test server, a file based on the update history and the difference information;

displaying, by the test server, information of the updated file when a request to access the test server is transmitted by the client terminal;

detecting, by the application, a request of deployment;

transmitting, by the application, the request to the management server;

detecting, by the management server, difference information between file management information of the test server and file management information of the production server;

transmitting, by the management server, the detected difference information to the production server;

updating, by the production server, a file based on the difference information; and

displaying, by the production server, information of the updated file when a request to access the production server is transmitted by the client terminal;

whereby the file of the production server is synchronized with the file of the client terminal

(2) A system comprising a client terminal, a management server, a test server and a production server, wherein the system is adapted to implement the file synchronization method according to the above item (1).

### BRIEF DESCRIPTION OF THE DRAWING

FIG. 1 is a block diagram of a system adapted to implement a file synchronization method of the present invention.

FIG. 2 is a schematic diagram showing an example of a file edited by a user and a Web page.

FIG. 3 is a schematic diagram showing a sequence when a user edits and saves a file.

FIG. 4 is a schematic diagram showing a sequence when a user requests deployment.

### DETAILED DESCRIPTION

Hereinafter, a file synchronization method of the present invention will be described in detail with reference to the drawings.

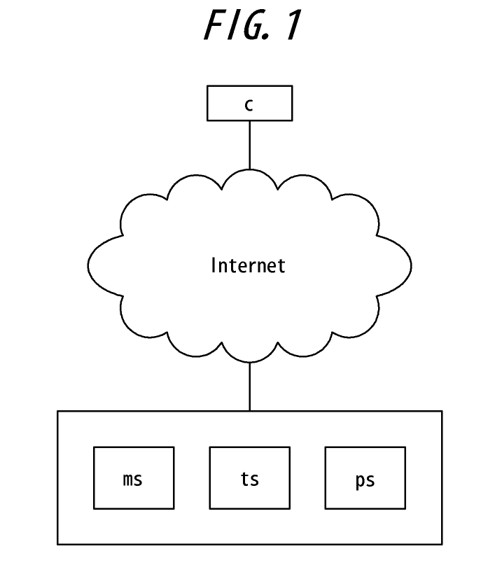

FIG. 1 is a block diagram of a system adapted to implement a file synchronization method of the present invention.

This system includes a client terminal c, a management server ms, a test server ts and a production server ps. The client terminal c is connected to the Internet.

An application (hereinafter, referred to as “SyncTool”) for managing file synchronization is installed on the client terminal c. Only a software (text editor) having text edit function other than SyncTool should be installed on the client terminal c but other special setting in the client terminal c is not necessary.

Access to the test server ts is restricted so that the test server ts can accept only access from a predetermined user.

It is noted that, although the management server ms, the test server ts and the production server ps are integrated as one system in this embodiment, they may be individually connected to the Internet. In addition, although one production server ps is used in this embodiment, several production servers ps may be used.

For example, a case where a user has a home page for selling products and adds a new product “product D” into a product list of the home page is considered.

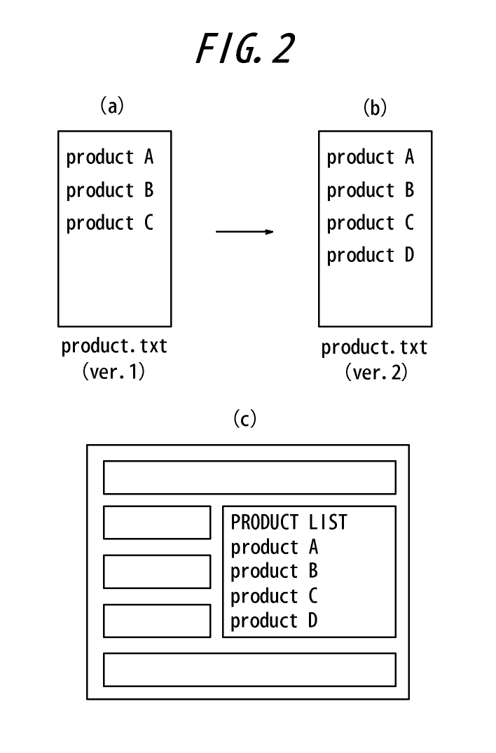

Firstly, the user opens a predetermined file “product.txt” in a directory in the client terminal c, which SyncTool is managing, adds “product D” to the file as shown in FIG. 2 (a) (b), and saves the file “product.txt”. It is assumed that the file “product.txt” is updated from ver.1 to ver.2 by this operation.

According to the technology of the present invention described below, it can be confirmed by accessing the test server ts via a browser of the client terminal c that “product D” is added into the product list of the home page as shown in FIG. 2 (c).

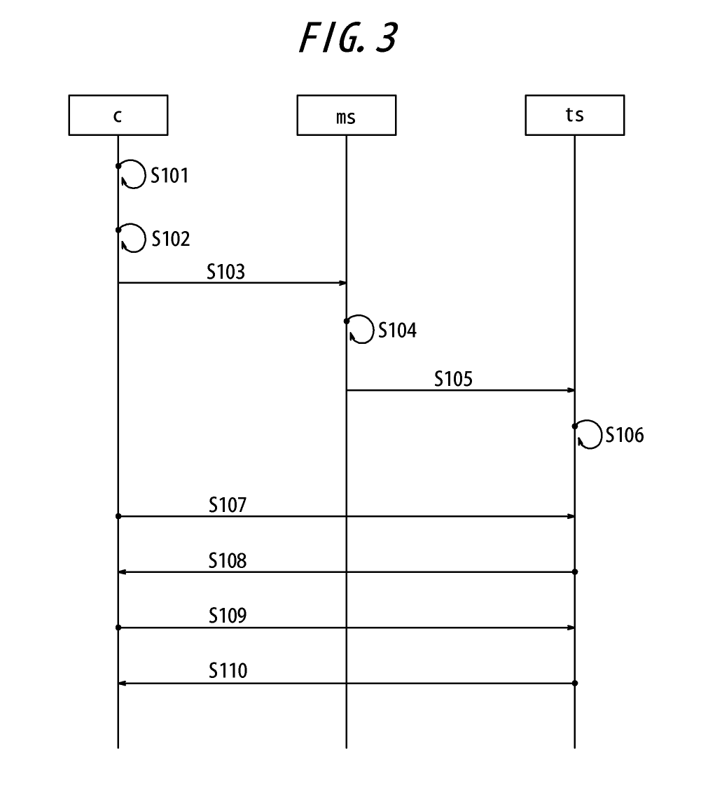

With reference to FIG. 3, a sequence when the user edits and saves the file in a system of the present embodiment will be described.

In step S101, SyncTool detects that the file “product.txt” in a directory under its management is updated.

SyncTool manages a directory of the client terminal c and a directory of the management server ms and synchronizes a file in the directory of the management server ms with a file in the directory of the client terminal c. The directories of the test server ts and the production server ps are equivalent to “htdocs” in Apache and associated with a Web page by the management server ms.

In step S102, SyncTool creates an update history and difference information of the updated file “product.txt”. In this embodiment, the version of the file “product.txt” is ver.1 before update and ver.2 after update.

In step S103, SyncTool transmits the update history and the difference information of the file “product.txt” to the management server ms. In this embodiment, the update history includes information that the file “product.txt” is updated from ver.1 to ver.2 and the difference information of the file “product.txt” includes information that “product D” is added.

In step S104, the management server ms updates a file “product.txt” in the management server ms based on the update history and the difference information of the file “product.txt”. In this embodiment, the file “product.txt” in the management server ms, which is ver.1 before update is updated to ver.2.

In step S105, the management server ms transmits the update history and the difference information of the file “product.txt” to the test server ts.

In step S106, the test server ts updates a file “product.txt” in the test server ts based on the update history and the difference information of the file “product.txt”. In other words, the file “product.txt” in the test server ts becomes ver.2.

In step S107, when the user transmits a request to access the test server ts, in step S108, the test server ts displays contents of an updated Web page, namely FIG. 2(c).

In step S109, when the user transmits a request to output a log to the test server ts, in step S110, the test server ts displays contents of the log through SyncTool. The log includes access log and an error log, which are used, for example, when the user analyzes an error.

According to the present invention, the user can build a Web server by using a text editor in the client terminal c without setup work such as installation of a specific application on the test server ts and the production server ps. In addition, the user can confirm a home page in the test server ts via a browser. In this way, it is possible to create a Web application by simple work without professional knowledge.

Next, the user checks contents displayed by the test server ts as shown in FIG. 2 (c) via a browser of the client terminal c. After confirming that the contents are correctly updated, the user transmits a request of deployment to the production server ps. This request of deployment is done by a simple operation such as clicking a predetermined button in SyncTool.

According to the technology of the present invention described below, once a request of deployment is transmitted, the user can confirm that the contents displayed in the test server ts are correctly updated in the production server ps by accessing the production server ps via a browser of the client terminal c in a similar manner that the user confirms the contents displayed in the test server ts.

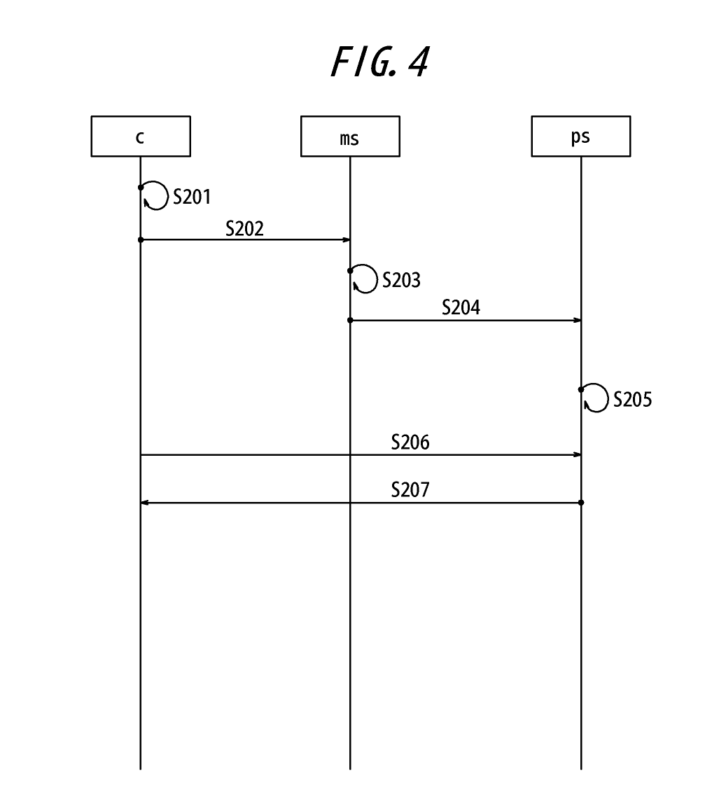

With reference to FIG. 4, a sequence when the user requests the deployment in the system of the present embodiment will be described.

It is assumed that, before the user transmits the request of deployment, the test server ts has the file “product.txt” of ver.2 and the production server ps has the file “product.txt” of ver.1.

In step S201, SyncTool detects a request of deployment from the user.

In step S202, SyncTool transmits the detected request of deployment to the management server ms.

In step S203, the management server ms detects difference information between file management information of the test server ts and file management information of the production server ps. In this embodiment, based on the file management information that the test server ts has the file “product.txt” of ver.2 and the production server ps has the file “product.txt” of ver.1, the difference information is detected.

In step S204, the management server ms transmits the detected difference information to the production server ps. In this embodiment, the management server ms transmits the difference information (product D) of the files “product.txt” to the production server ps.

In step S205, the production server ps updates the file in the production server ps based on the transmitted difference information. In this embodiment, the production server ps updates the version of the file “product.txt” to ver.2.

In step S206, when the user transmits a request to access the production server ps, in step S207, the test server ts displays contents of an updated Web page.

In the present invention, the user does not have to prepare an environment of the test server and the production server and therefore, does not have to deal with environment-dependent problems. In addition, a Web application can be made by simple operation without taking trouble of deployment such as file transfer.

In addition, the file synchronization method of the present invention is advantageous when several developers set up a Web server collectively. Conventionally, since several developers respectively code the program in each client terminal and upload each program files to a test server ts at some point, they have to care about timing of file synchronization among themselves. In the present invention, a file in the client terminal c of each developer is synchronized with a file in the test server ts in real time. Therefore, each developer can go on coding in a comfortable environment without need for consideration of file synchronization with other developers. It is noted that version control of a file in the management server ms can be done by using a version control system such as CVS.

What is claimed is:

1. A method of synchronizing files on a system including a client terminal, a management server, a test server and a production server, the method comprising the steps of:
detecting, by an application installed on the client terminal, update of a file in a directory which the application manages;
creating, by the application, an update history and difference information of the updated file;
transmitting, by the application, the update history and the difference information to the management server;
updating, by the management server, a file based on the update history and the difference information;
transmitting, by the management server, the update history and the difference information to the test server;
updating, by the test server, a file based on the update history and the difference information;
displaying, by the test server, information of the updated file when a request to access the test server is transmitted by the client terminal;
detecting, by the application, a request of deployment;
transmitting, by the application, the request to the management server;
detecting, by the management server, difference information between file management information of the test server and file management information of the production server;
transmitting, by the management server, the detected difference information to the production server;
updating, by the production server, a file based on the difference information; and
displaying, by the production server, information of the updated file when a request to access the production server is transmitted by the client terminal;
whereby the file of the production server is synchronized with the file of the client terminal.

2. A system comprising a client terminal, a management server, a test server and a production server, wherein the system is adapted to implement the file synchronization method according to claim 1.
